(19) United States
(12) Patent Application Publication
(10) Pub. No.: US 2007/0099513 A1
(43) Pub. Date: May 3, 2007

(54) Plug-in device and method of making the same

(76) Inventors: Dan J. Savage, Syracuse, NY (US); Dan S. Carroll, Baldwinsville, NY (US); David G. Underwood, Phoenix, NY (US); Larry P. Gannon, Marcellus, NY (US)

Correspondence Address: ABB Inc.;Legal Dept. - 4U6, 29801 Euclid Avenue, Wickliffe, OH, 44092-1832, US

(21) Appl. No.: 11/263,341

(22) Filed: Oct. 31, 2005

(51) Int. Cl. H01R 33/00

(52) U.S. Cl. 439/638

(57) ABSTRACT

The present invention is directed to a plug-in device having a printed circuit board. A plurality of conductor pins arranged in a circular configuration are surface mounted or through-hole mounted to the circuit board and extend outwardly therefrom. A plastic base with a key shaft is secured to the circuit board over the conductor pins. The key shaft and the conductor pins are adapted for insertion into a socket. The circuit board may be insert-molded into the plastic base, or the plastic base may be pre-formed and secured to the circuit board by heat staking and/or adhesive.

### BACKGROUND OF THE INVENTION

The present invention is directed toward plug-in devices and, more particularly, toward plug-in control devices and their manufacture.

Conventionally, a plug-in device, such as an industrial timer, has a case or housing for enclosing internal circuitry. The housing is secured to a base having pin conductors that are adapted for insertion into a socket to form an electrical connection therewith. Typically, the base is formed of plastic and has a plurality of outwardly-extending conductor pins arranged in a circular configuration. The conductor pins are composed of metal, or are metal plated, and are typically hollow. Usually, the conductor pins are swaged into the plastic base. Sometimes they are insert-molded into the base. The conductor pins are electrically connected to the internal circuitry so as to maintain a minimum spacing (for both creepage and clearance) required by UL508, CSA C22.2 No. 14-M91 and the CE Low Voltage Directive 73/23/EEC. In order to attain such spacing, the conductor pins are usually connected to terminals of the internal circuitry by discrete wires, which have different colors to help ensure that proper connections are made. The wires are connected to the terminals and the conductor pins by soldering, with inner ends of the wires being soldered to the terminals of the internal circuitry first. More specifically, the inner ends of the wires are wave soldered to the terminals before the housing is secured to the base. Once the inner ends of the wires are soldered to the terminals, outer ends of the wires are inserted into the conductor pins and the housing is attached to the base. The base with the conductor pins is then dipped into a solder pot to solder the outer ends of the wires to the pin connectors. Since the base is subjected to a high temperature when it is dipped into the solder pot, the base must be formed from a high temperature plastic, such as a polyphenylene sulfide, which is commercially available from Phillips Petroleum under the tradename RYTON R-4.

As can be appreciated, the foregoing conventional method of manufacturing a plug-in device is complicated, labor intensive and susceptible to human error. In addition, the method requires the base to be formed from a high temperature plastic. High temperature plastics are typically expensive and brittle, which can cause yield and reliability problems.

U.S. Pat. No. 5,246,386 to Nanjo discloses a method of forming a base for a plug-in device that avoids some of the foregoing problems. In the method of the Nanjo patent, a base is formed from high temperature plastic in an injection molding process. The base includes an outer surface with a plurality of shafts extending outwardly therefrom. The shafts are arranged in a circular configuration and are disposed adjacent to through-holes, respectively. A circuit is formed on an interior surface of the base by chemical plating. The shafts are chemically plated with metal so as to form conductor pins, and the through-holes are chemically plated with metal so as to form electrical conductors that connect the conductor pins to the circuit.

The method of the Nanjo patent eliminates the problems associated with using discrete wires, but still requires the base to be made from high temperature plastic. In addition, an extensive amount of plating must be performed.

Based on the foregoing, there exists a need in the art for an improved plug-in device and method of making the same. The present invention is directed to such a device and method.

### SUMMARY OF THE INVENTION

In accordance with the present invention, a plug-in device is provided and includes a circuit board having a first side with conductive tracks and a second side. A plastic base is secured to the circuit board and is disposed on the second side thereof. The plastic base is configured for at least partial insertion into a socket and a portion of the plastic base extends through the circuit board. A plurality of conductor pins are secured to the circuit board and extend through the plastic base. The conductor pins each have a first portion disposed in the plastic base and a second portion extending outwardly from the plastic base. Electrical circuitry is disposed on the first side of the circuit board and is electrically connected to the conductive tracks and the conductor pins.

Also provided in accordance with the present invention is a plug-in device having a circuit board with conductive tracks and at least one dielectric layer. A plastic base is secured to the circuit board. The plastic base has a key shaft adapted for insertion into a socket. A plurality of conductor pins are secured to the circuit board and extend through the plastic base. The conductor pins are disposed around the key shaft.

A method of forming a plug-in device is also provided in accordance with the present invention. In accordance with the method, conductor pins and a circuit board with conductive tracks are provided. The conductor pins are soldered to the circuit board so as to be connected to the conductive tracks. A base is molded from a plastic resin with the circuit board as an insert such that the base has a key shaft adapted for insertion into a socket and such that the conductor pins extend through the base.

Another method of forming a plug-in device is provided in accordance with the present invention. In accordance with the method, conductor pins, a circuit board and plastic base are provided. The circuit board has conductive tracks and a plurality of through-holes. The plastic base has a first side with a key shaft extending therefrom and a second side with a plurality of studs extending therefrom. A plurality of pin passages extend between the first and second sides of the plastic base. The conductor pins are soldered to the circuit board so as to be connected to the conductive tracks. The plastic base is disposed over the circuit board such that the conductor pins extend through the pin passages and the studs extend through the through-holes. The studs are heat staked to secure the plastic base to the circuit board.

### BRIEF DESCRIPTION OF THE DRAWINGS

The features, aspects, and advantages of the present invention will become better understood with regard to the following description, appended claims, and accompanying drawings where:

FIG. 1 is an elevational view of a first plug-in device embodied in accordance with the present invention;

FIG. 2 is an elevational view of the first plug-in device with an outer housing removed;

FIG. 3 is a side view of a conductor pin of the first plug-in device;

FIG. 4 is a partial sectional view of the first plug-in device, showing the conductor pin mounted to a circuit board;

FIG. 5 is a sectional view of a portion of a second plug-in device embodied in accordance with the present invention, showing a conductor pin mounted to a circuit board;

FIG. 6 is a partial sectional view of a mold with the circuit board of the first plug-in device disposed therein;

FIG. 7 is a bottom plan view of the first plug-in device;

FIG. 8 is a top plan view of a socket;

FIG. 9 is a schematic view of circuitry of the first plug-in device connecting a power source to a load;

FIG. 10 is a top plan view of a base of a third plug-in device; and

FIG. 11 is a side cross-sectional view of a portion of the third plug-in device, including the base.

### DETAILED DESCRIPTION OF EXEMPLARY EMBODIMENTS

It should be noted that in the detailed description that follows, identical components have the same reference numerals, regardless of whether they are shown in different embodiments of the present invention. It should also be noted that in order to clearly and concisely disclose the present invention, the drawings may not necessarily be to scale and certain features of the invention may be shown in somewhat schematic form.

As used herein, the acronym “PCB” shall mean “printed circuit board”.

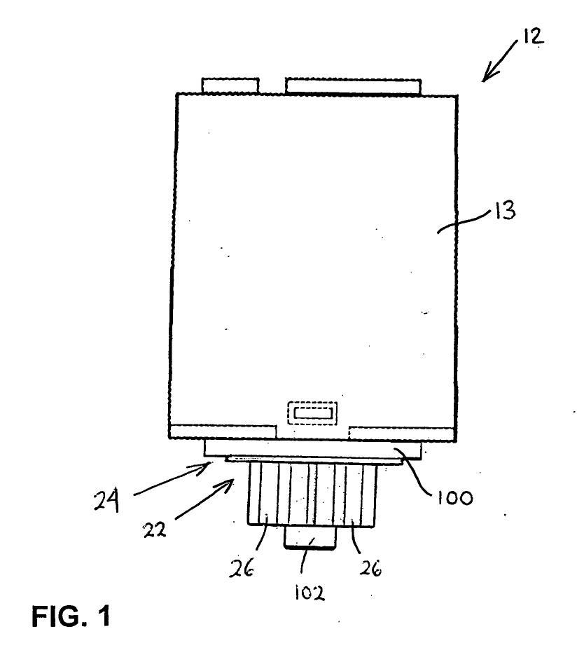

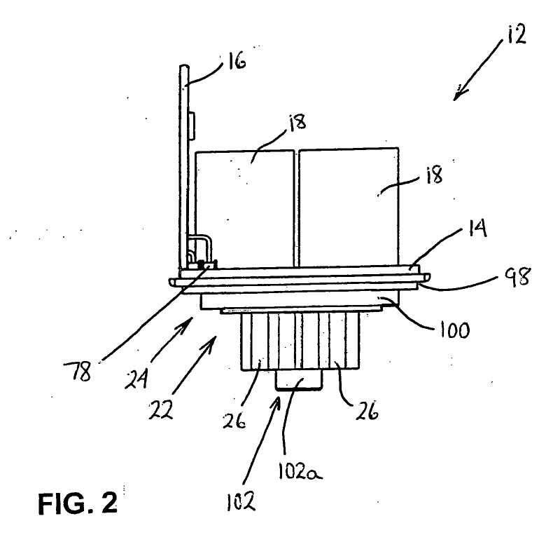

Referring now to FIGS. 1 and 2, there is shown a plug-in device 12 embodied in accordance with the present invention. The plug-in device 12 is a control device, such as an industrial timer; however, the present invention is not limited to control devices or industrial timers. The plug-in device 12 includes an outer housing 13, which has been removed in FIG. 2 to better show the interior of the switching device. In addition to the housing 12, the plug-in device 12 generally includes a base PCB 14, one or more electrical components 18 and a plug-in base assembly 22 that includes a base 24 with a plurality of conductor pins 26 secured thereto and extending therefrom. The plug-in device 12 may further include a control PCB 16. The manufacture of the plug-in device 12 includes securing the conductor pins 26 to the base PCB 14 and then forming the base 24 over the base PCB 14, as will be described more fully below.

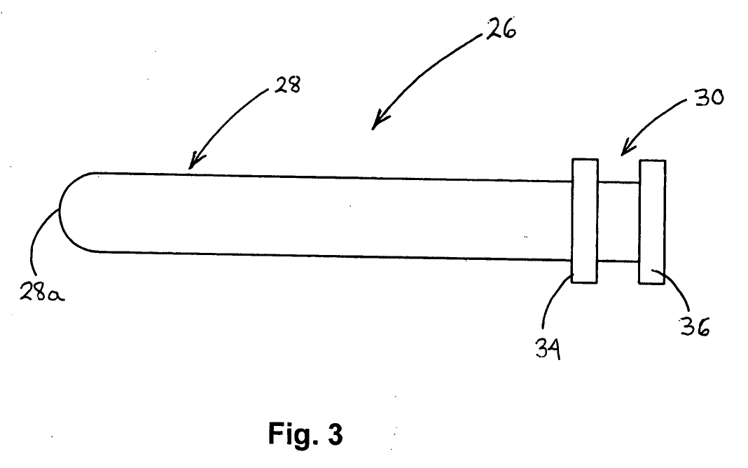

Referring now to FIG. 3, one of the conductor pins 26 is shown. Each conductor pin 26 is composed of an electrically conductive metal, such as copper or alloys of copper, iron, cobalt, silver, gold, nickel and other conductive metals. An example of such an alloy is Kovar® alloy, which is an iron-nickel-cobalt alloy that is commercially available from Carpenter Technology Corporation. Each conductor pin 26 is elongated and includes a body portion 28 joined to an anchor portion 30. The body portion 28 is adapted for smooth insertion into a contact 31 of a socket 32 (shown in FIG. 8). Since the contacts 31 of the socket 32 are cylindrical (as is conventional), the body portion 28 has a smooth cylindrical surface and a rounded end 28a to facilitate insertion into the contacts 31 of the socket 32. In contrast to the body portion 28, the anchor portion 30 has a foot 36 and at least one protrusion 34. The protrusion 34 is adapted to promote the mechanical anchoring of the conductor pin 26 to the base 24 and to facilitate the shedding of axial forces that are applied to the conductor pin 26 during the insertion and retraction of the base 24 into and from the socket 32, respectively. In the embodiment shown in FIG. 3, the protrusion 34 is annular or ring-shaped. In other embodiments, the protrusion(s) 34 may have different shapes. For example, the protrusion(s) 34 may be frusto-conical, triangular, barbed, etc.

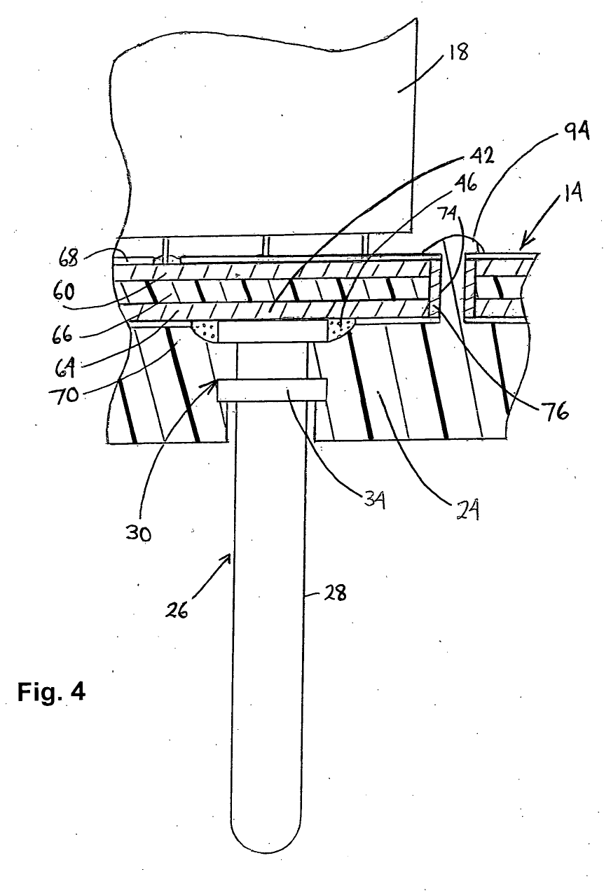

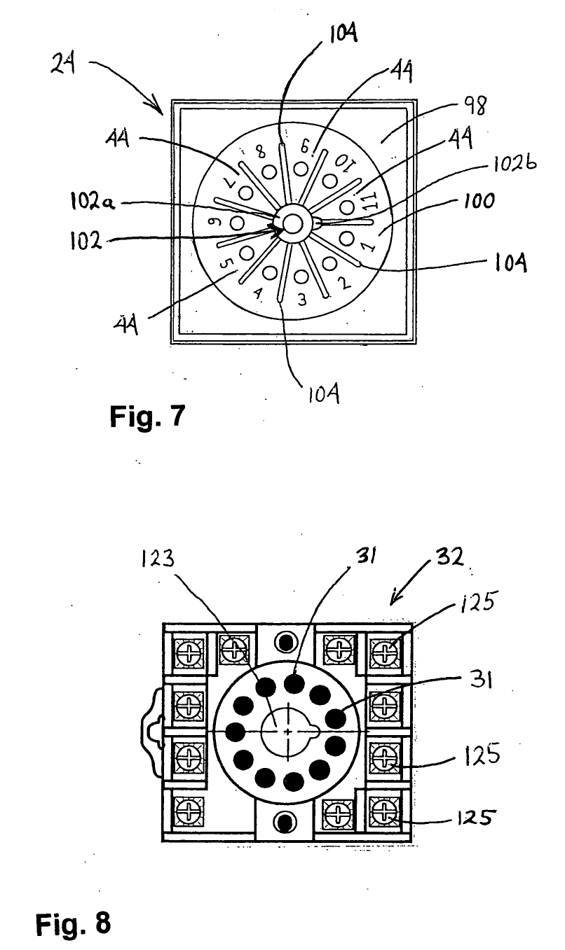

The conductor pins 26 are fixedly mounted to the base PCB 14 so as to extend from a bottom side thereof. In an embodiment shown in FIG. 4, the conductor pins 26 are secured to pads 42, respectively, on the bottom side of the base PCB 14. The pads 42 are arranged in a pattern corresponding to isolation areas 44 (shown in FIG. 7) that are formed in the base 24, as will be described further below. The pads 42 are composed of copper and may be coated with thinner layers of nickel and gold. Typically, the pads 42 are greater than 20 μm thick. The conductor pins 26 are secured to the pads 42 using a suitable surface mounting technique known in the art. For example, in one such known mounting technique, a solder paste is deposited on the pads 42, respectively, such as through a stencil patterned with openings corresponding to the locations of the pads 42. The solder paste includes flux and a solder, which may be an alloy of tin and one or more other metals, such as silver, gold, lead, zinc, bismuth and/or copper. The conductor pins 26 are placed in a jig and pressed against the pads 42. With the jig and the base PCB 14 so positioned, the jig and the base PCB 14 are placed into an infrared reflow furnace and are heated to an elevated temperature, which causes the solder to reflow around and over the feet 36. The jig and the base PCB 14 are then removed from the reflow furnace and allowed to cool, which causes the solder to harden, thereby forming solder joints 46 that secure the conductor pins 26 to the pads 42.

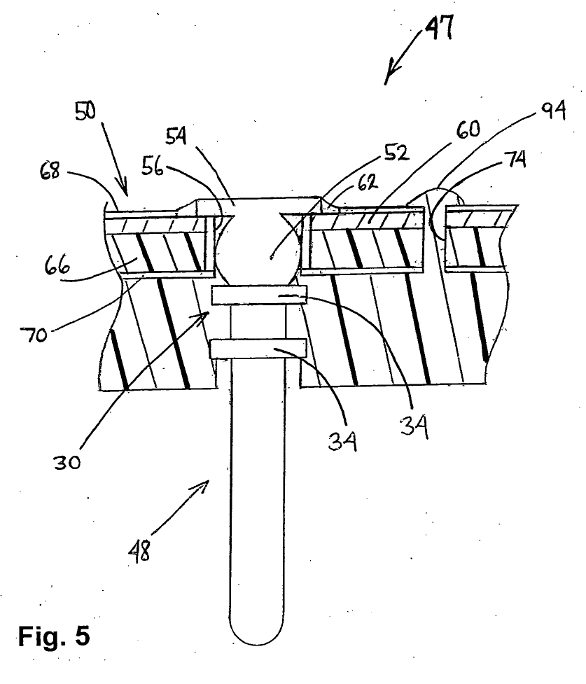

Surface mounting of the conductor pins 26 permits the electrical components 18 to be mounted directly over the conductor pins 26 (as shown in FIG. 4), which provides flexibility in the arrangement of the components of the plug-in device 12. It should be appreciated, however, that the present invention is not limited to the surface mounting of the conductor pins 26. For example, FIG. 5 shows a portion of a plug-in device 47 constructed in accordance with another embodiment of the present invention, wherein conductor pins 48 are secured to a base PCB 50 using a through-hole mounting technique. The plug-in device 47 has the same construction as the plug-in device 12, except for the differences described below. Conductor pins 48 have the same construction as the conductor pins 26, except the anchor portions 30 of the conductor pins 48 each additionally have a bulbous portion 52 joined to a top plate portion 54. Base PCB 50 has the same construction as the base PCB 14, except for the differences described more fully below

In a through-hole technique, pin holes 56 are formed in the base PCB 50 in a pattern corresponding to the isolation areas 44 in the base 24. The pin holes 56 are conductive, i.e., are defined by conductive interior walls, and extend completely through the base PCB 50. Each of the pin holes 56 has a width or diameter that is slightly larger than the width or diameter of the bulbous portions 52 of the conductor pins 48 so as to accommodate the bulbous portions 52 of the conductor pins 48, respectively. The top plate portions 54 of the conductor pins 48 are disposed above the pin holes 56 and are soldered to top conductor tracks 60 of the base PCB 50 by a solder wave in which molten solder flows across the top side of the base PCB 50. The molten solder fills the voids between the conductor pins 48 and the pin holes 56 and forms solder joints 62 between the conductor pins 48 and the conducting pin holes 56 and the top conductor tracks 60 in the base PCB 50. The solder used to bond the conductor pins 48 to the pin holes 56 and the top conductor tracks 60 may be the same as that used in the surface mounting technique described above.

In the paragraphs that follow, various aspects of the invention are described that apply both to the plug-in device 12 and the plug-in device 47. Accordingly, where applicable, components of the invention are provided with reference numerals for both embodiments, notwithstanding the fact that only one embodiment may be shown in a referenced drawing.

The base PCB 50 is single sided, i.e., has conductors tracks on only one side of the base PCB 50, namely top conductor tracks 60, whereas the base PCB 14 is double sided, i.e., has conductor tracks on both sides of the base PCB 14, namely top conductor tracks 60 and bottom conductor tracks 64. The base PCB 14 and the base PCB 50 may have conventional laminate constructions, wherein the base PCB 14 is formed from one or more insulating or dielectric sheets and two or more copper sheets or foils, and the base PCB 50 is formed from one or more insulating or dielectric sheets and one or more copper sheets. Each dielectric sheet may be comprised of a fiber web impregnated with a thermoset resin, such as phenol formaldehyde or an epoxy. Top and bottom solder resist layers 68, 70 may be deposited on the top and bottom sides of each of the base PCB 14 and the base PCB 50.

A plurality of anchor passages or holes 74 extend through the base PCB 14 and the base PCB 50. The holes 74 are provided for securing the base PCB (14, 50) to the base 24, as will be described more fully below. In the base PCB 14, the anchor holes 74 may also serve as connector holes for electrically connecting the bottom conductor tracks 64 to the top conductor tracks 60, as is shown in FIG. 4. In such a case, the anchor holes 74 are formed before the copper foil(s) are deposited on the dielectric sheet(s) 66. In this manner, when the copper is deposited on the dielectric sheet(s) 66, the copper coats the interior walls defining the anchor holes 74, thereby forming conductive connectors 76.

In the base PCB 50, the anchor holes 74 may be formed after the copper foil(s) are deposited on the dielectric sheet(s) 66. In this manner, the interior walls defining the anchor holes 74 are not coated with copper, as is shown in FIG. 5. The pin holes 56, however, are formed in the base PCB 50 before the copper foil(s) are deposited on the dielectric sheet(s) 66 so that when the copper is deposited on the dielectric sheet(s) 66, the copper coats the interior walls defining the pin holes 56, thereby making them conductive.

In the embodiment of the invention shown in FIG. 4, wherein the conductor pins 26 are surface mounted to the base PCB 14, the bottom conductor tracks 64 electrically connect the pads 42 to the conductive connectors 76 (as shown), or to wiring (not shown). The conductive connectors 76 extend through the base PCB 14 and may be located toward an outer edge of the base PCB 14, whereas the wiring may extend around an outer edge of the base PCB 14 or through a notch or opening formed in the base PCB 14, toward an outer edge thereof. The conductive connectors 76 or wiring, are electrically connected to the top conductor tracks 60 and/or to a pin header 78, or other type of connector, mounted to the top surface of the base PCB 14.

In the embodiment where the conductor pins 48 are through-hole mounted to the base PCB 50, the pin holes 56 are electrically connected to the top conductor tracks 60, respectively.

In the embodiments where the plug-in device (12, 47) is an industrial timer, the electrical components 18 include relays, such as solid state relays. The electrical components 18 may be surface mounted (as shown in FIG. 4) or through-hole mounted to the base PCB (14, 50) or may be secured to a connector mounted to the base PCB (14, 50). The electrical components 18 are mounted to the base PCB (14, 50) so as to be disposed on a top side of the base PCB (14, 50), proximate to the top surface of the base PCB (14, 50). Terminals of the electrical components 18 are electrically connected to the top conductor tracks 60 of the base PCB (14, 50), which are electrically connected to the pin header 78 and/or the pin holes 56 (for the conductor pins 48, which are through-hole mounted), or the conductive anchor holes 74 or wiring (for the conductor pins 26, which are surface mounted).

After the base PCB (14, 50) with the conductor pins (26, 48) and the electrical components 18 has been completely populated and soldered, the base PCB (14, 50) is insert molded into the base 24, which is comprised of a dielectric thermoplastic resin. In one embodiment of the present invention, the thermoplastic resin that is used to form the base 24 is comprised of Noryl® 1250 resin, which is a modified polyphenylene ether polymer commercially available from GE Plastics. Other thermoplastic resins that may be used to form the base include polyethylene terephthalate (PET), polystyrene, polybutylene terephthalate (PBT) and PBT alloys, polypropylene and propylene alloys, thermoplastic polyurethane, polyvinyl chloride (PVC), polyesters, polypropylene and polystyrene alloys, polyethylene, nylon, polyacetal, styrene acrylonitrile (SAN), styrene maleic anhydride (SMA), acrylonitrile-butadiene-styrene copolymer (ABS), acrylics and cellulosics. High temperature thermoplastics, such as polycarbonate and polycarbonate alloys, polyetherimide, polysulfone, polyethersulfone, amorphous polyamides and fluoropolymers may also be used, but may not be as desirable due to higher cost and/or undesirable properties, such as brittleness. The foregoing list is not meant to be exhaustive, but only illustrative of the various thermoplastic resins that can be used to form the base 24 in the practice of the present invention.

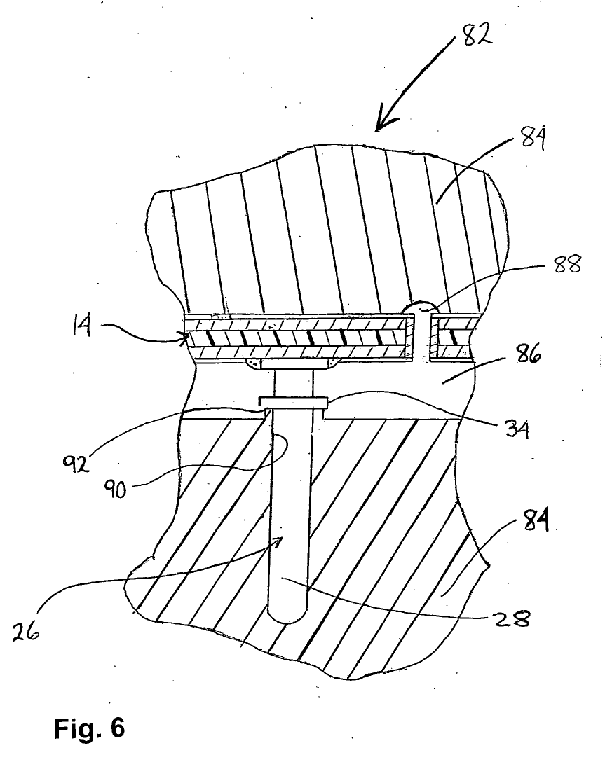

Referring now to FIG. 6, the base PCB (14, 50) is disposed in a mold 82 of an injection molding machine. The mold 82 includes a pair of platens 84 (at least one of which is movable) that cooperate to define a cavity 86, which is configured to hold the base PCB (14, 50) and to shape the molten thermoplastic so as to form the base 24 thereon. The base PCB (14, 50) is disposed in the cavity 86, with the anchor holes 74 aligned with recesses 88 in one of the platens 84. The anchor portions 30 of the conductor pins (26, 48) are disposed in the cavity 86, however, the body portions 28 of the conductor pins (26, 48) extend out of the cavity 86 through passages 90 in the other one of the platens 84. The passages 90 cooperate with lowermost ribs 34 of the conductor pins (26, 48) to form shut off points 92 where the flow of molten thermoplastic is pinched off. The shut-off openings 90 are sized to tightly receive the body portions 28 of the conductor pins (26, 48) to prevent the flow of molten thermoplastic resin out of the cavity 86, but not so tightly so as to damage the conductor pins (26, 48).

With the base PCB (14, 50) so disposed in the cavity 86, molten thermoplastic resin is injected into the cavity 86 under pressure. The molten thermoplastic flows against the bottom surface of the base PCB (14, 50) through the anchor holes 74 and into the recesses 88, thereby forming anchors 94 for securing the base 24 to the base PCB (14, 50). The molten thermoplastic also flows around and over the anchor portions 30 of the conductor pins (26, 48) and is pinched off at the shut-off points 92. After a predetermined period of time, the injection of the molten thermoplastic into the cavity 86 is shut-off and the thermoplastic in the cavity 86 is allowed to cool. When the thermoplastic is sufficiently cooled, the mold 82 is opened and the base PCB (14, 50) with the base 24 formed thereon is removed.

With reference now to FIGS. 2 and 7, the base 24, as formed in the foregoing injection molding process, includes a mount portion 98 joined to a plug portion 100. The mount portion 98 has a top side that adjoins a bottom side of the base PCB (14, 50). The mount portion 98 may have a shape corresponding to an open end of the outer housing 13, which may be rectangular, or more specifically square, as shown in FIG. 7. The plug portion 100 may be circular, as shown in FIG. 7. A positioning projection or key shaft 102 is joined to a central portion of the plug portion 100 and extends downwardly therefrom. The key shaft 102 has a cylindrical body 102a with a key ridge 102b extending radially outward therefrom for ensuring that the plug-in device (12, 47) is properly plugged into the socket 32. A plurality of downwardly-extending isolation ribs 104 are joined to a bottom surface of the plug portion 100 and are disposed around the key shaft 102. More specifically, the isolation ribs 104 extend radially outward from the key shaft 102 and are spaced apart so as to form a pattern of spokes or rays. With this arrangement, the isolation ribs 104 form the isolation areas 44 from which the conductor pins (26, 48) extend. Since plug-in devices are conventionally provided with eight or eleven conductor pins, eight or eleven isolation ribs 104 are typically provided so as to form eight or eleven isolation areas 44, respectively. In the shown embodiments, the base 24 is provided with eleven conductor pins (26, 48) and therefore, has eleven isolation areas 44. The present invention, of course, is not limited to a plug-in device having eight or eleven conductor pins; different numbers of conductor pins, such as six, twelve, or eighteen may be utilized.

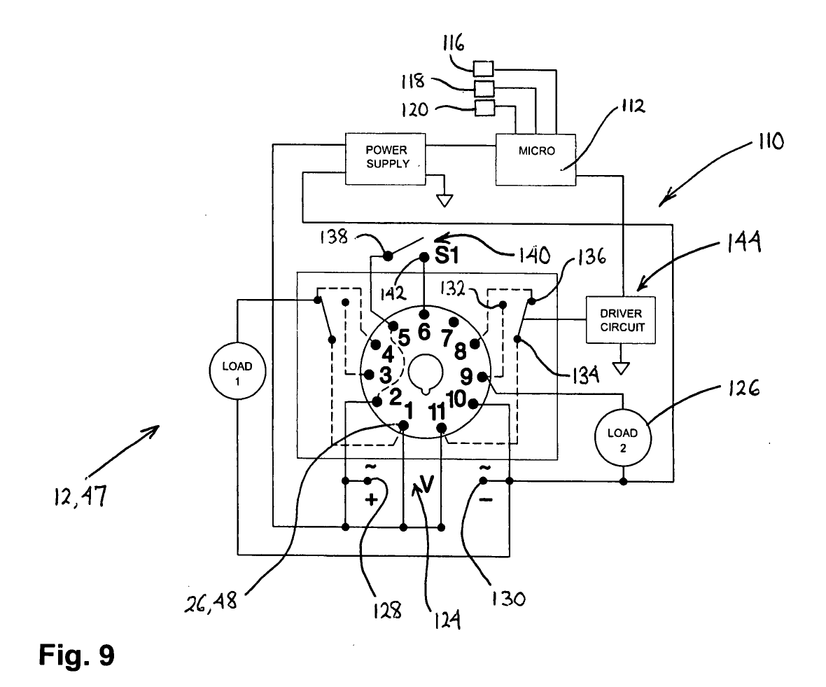

The base PCB (14, 50) is electrically connected to the control PCB 16 by the pin header 78 on the base PCB (14, 50) and a mating pin connector (not shown) on the control PCB 16. The control PCB 16 contains control circuitry 110 for controlling the electrical components 18. In the exemplary embodiment where the plug-in device (12, 47) is an industrial timer, the control circuitry 110 of the control PCB 16 has a microcontroller 112 (shown in FIG. 9) and may include a memory. The microcontroller 112 is operable to perform a plurality of timer control routines, such as delay on make, delay on break, recycle, single shot and interval and combinations of the foregoing, which are stored in the memory 114. First, second and third sets 116, 118, 120 of manually actuatable dip switches are mounted to a top end wall 122 of the outer housing 13 and are connected to the microcontroller 112. The first set 116 of first dip switches are operable to select a desired control routine based on the actuation pattern of the dip switches, whereas the second and third sets 118, 120 of dip switches are operable to select desired time periods for the control routines. Of course, other manually actuatable interface devices other than dip switches may be utilized for selecting control routines.

It should be appreciated that instead of providing a separate control PCB 16, the control circuitry 110 may be incorporated into the base PCB (14, 50).

Referring now to FIG. 8, the plug-in device (12, 47) is utilized by plugging the plug-in device (12, 47) into the socket 32, i.e., inserting the key shaft 102 into a center opening 123 of the socket 32 and the conductor pins (26, 48) are inserted into the contacts 31 of the socket 32. The contacts 31 connect the conductor pins (26, 48) to screw terminals 125 of the socket 32, which are connected to wiring of an external circuit. The socket 32 may be mounted to a DIN rail or to a planar surface.

In the embodiment where the plug-in device (12, 47) is an industrial timer, the plug-in device (12, 47) may be used to control the supply of power from a power source 124 (such as a battery) to a load 126, as is shown in FIG. 9. In FIG. 9, connections external to the plug-in device (12, 47), i.e., external connections, are shown by filled lines, whereas connections internal to the plug-in device (12, 47), i.e., internal connections, are shown by dashed lines. The external connections comprise the contacts 31 and the screw terminals 125 of the socket 32 and external wiring, whereas internal connections comprise top conductor tracks 60 and bottom conductor tracks 64 (for the conductor pins 26, which are surface mounted). A positive terminal 128 of the power source 124 is externally connected to conductor pins (26, 48) located at positions 2 and 11, while a negative terminal 130 of the power source 124 is externally connected to conductor pin (26, 48) located at position 10. The conductor pin (26, 48) located at position 9 is externally connected to the load 126. A first contact 132 of the control component 18 is internally connected to the conductor pin (26, 48) located at position 9, while a second contact 134 of the control component 18 is internally connected to the conductor pin (26, 48) located at position 11 and a third contact 136 of the control component 18 is internally connected to the conductor pin (26, 48) located at position 8. The conductor pin (26, 48) located at position 2 is internally connected to conductor pin (26, 48) located at position 5, which is externally connected to a first contact 138 of an initiate switch 140, such as a momentary pushbutton. A second contact 142 of the initiate switch 140 is externally connected to conductor pin (26, 48) located at position 6, which is internally connected (not shown) to the microcontroller 112. The microcontroller 112 is internally connected to a control circuit 144 of the control component 18. In the embodiment where the control component 18 is a relay, the control circuit 144 is comprised of suitably chosen components for blocking and conducting relay coil current.

With the plug-in device (12, 47) connected between the power source 124 and the load 126 as described above, actuation of the initiate switch 140 causes power from the power source 124 to be provided as an enable signal to the microcontroller 112 through conductor pins (26, 48) located at positions 2, 5 and 6. It should be appreciated, however, that an external initiate switch circuit is only required for certain standard timing functions and is not generally required for all timing functions. In response to the receipt of the enable signal, the microcontroller 112 performs a control routine that has been selected through the first set 116 of dip switches, such as a delay on make routine. In accordance with this routine, the microcontroller 112 waits for a selected period of time after the receipt of the enable signal and then sends a signal to the control circuit 144 of the control component 18, instructing the control component 18 to provide a connection between conductor pins (26, 48) located at positions 9 and 11, thereby supplying power to the load 126.

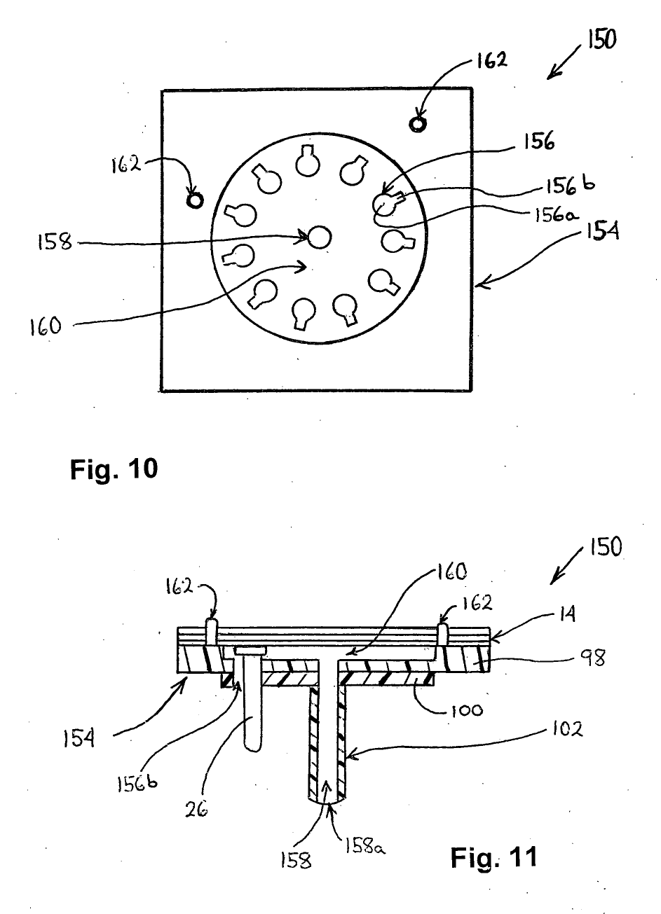

Referring now to FIGS. 10 and 11, there are shown portions of a plug-in device 150 constructed in accordance with still another embodiment of the present invention. The plug-in device 150 has substantially the same construction and operation as the plug-in device 12, except for the differences described below. The manufacture of the plug-in device 150 differs from the manufacture of the plug-in device 12. As in the plug-in device 12, the conductor pins (26, 48) are first secured to a base PCB (14, 50) and then a base 154 is secured to the base PCB (14, 50) over the conductor pins 152. The base 154 of the plug-in device 150, however, is not molded over the base PCB (14, 50). Rather, the base 154 is formed apart from the base PCB (14, 50) and is then secured to the base PCB (14, 50) by heat staking and/or application of an adhesive, as described more fully below. FIG. 10 shows a top plan view of the base 154, while FIG. 11 is a side cross-sectional view of the base PCB (14, 50) disposed over the base 154, with all but one of the conductor pins (26, 48) removed and the electrical components 18 removed to better show certain features of the plug-in device 150.

The conductor pins (26, 48) do not have the protrusions 34. The portion of each conductor pin (26, 48) that extends through the base 154 is smooth and adapted for facile insertion through a pin passage 156 formed in the base 154. The conductor pins (26, 48) are secured to the base PCB (14, 50) as described above with regard to the plug-in devices 14, 47.

The base 154 has the same construction as the base 24, except for the differences described below. As set forth above, the base 154 is pre-formed in a plastic molding process and is then secured to the base PCB (14, 50) over the conductor pins 152. The base 154 has a plurality of pin passages 156 that are disposed around the key shaft 102 and extend through the mount portion 98 and the plug portion 100 of the base 154. Each of the pin passages 156 has a substantially cylindrical main section 156a with a diameter slightly larger than the diameter of a conductor pin 152 so as to permit the conductor pin 152 to move smoothly therethrough. A vent section 156b adjoins the main section 156a. A key passage 158 extends through the key shaft 102, the mount portion 98 and the plug portion 100. A shallow, disc-shaped pocket or recess 160 is formed in a top surface of the mount portion 98. Openings for the pin passages 156 and an opening for the key passage 158 are disposed in the recess 160. Outward from the recess 160, a plurality of studs 162 are joined to the top surface of the mount portion 98 and extend upwardly therefrom. The studs 162 are positioned so as to be aligned with the anchor holes 74 in the base PCB (14, 50) when the top surface of the base 154 is aligned with the base PCB (14, 50).

The base 154 is secured to the base PCB (14, 50) by aligning a bottom surface of the base PCB (14, 50) with the top surface of the mount portion 98 such that the conductor pins (26, 48) are aligned with the pin passages 156 and the studs 162 are aligned with the anchor holes 74. The base 154 is then moved toward the base PCB (14, 50) so that the conductor pins (26, 48) and the studs 162 move into and travel through the pin passages 156 and the anchor holes 74, respectively. The movement of the base 154 stops when the top surface of the base 154 abuts the base PCB (14, 50), at which point, the studs 162 extend through the anchor holes 74 and project above the top surface of the base PCB (14, 50), while the conductor pins (26, 48) extend through the pin passages 156 and project below the plug portion 100 of the base 154, as shown in FIG. 11. With the base 154 and the base PCB (14, 50) so positioned, the studs 162 are heat staked using a press connected to one or more heated process tips. If one tip is provided, the studs 162 are heat staked serially, whereas if a plurality of tips are provided, the studs 162 may be heat staked at the same time. The press may be manual, electric or pneumatic and each tip is composed of metal and has a cavity. The heat staking is performed by pressing the heated tip(s) against the studs 162 using the press. The pressure and heat applied to the studs 162 causes the studs 162 to melt and take the form of the cavity/cavities in the tip(s). The melted studs 162 are allowed to cool and the tip(s) removed, thereby forming the anchors 94, which secure the base 154 to the base PCB (14, 50). The studs 162 and the tip(s) may be configured to provide the anchors 94 with a high or low profile dome shape, a high or low profile rosette shape, a knurled shape, or a flush profile.

After the studs 162 have been heat staked to form the anchors 94. A measured amount of an adhesive, such as an epoxy adhesive, is injected into the key passage 158 through a bottom opening 158a thereof. The adhesive moves upward through the key passage 158, into the recess 160 and against the bottom surface of the base PCB (14, 50). As the adhesive is injected into the recess 160, air in the recess 160 is ejected through the vent sections 156b of the pin passages 156. The adhesive then moves into the vent sections 156b so as to be visible from outside the base 154. In this manner, the adhesive in the vent sections 156b provides a visual indication whether the adhesive is flowing properly so as to be evenly distributed around the recess 160 and the conductor pins (26, 48).

After the adhesive has been injected into the recess 160 as described above, the adhesive is allowed to cure. The cured adhesive forms a bond between the bottom surface of the base PCB (14, 50) and the top surface of the mount portion 98 within the recess 160, thereby further securing the base 154 to the base PCB (14, 50).

In the description of the invention set forth above, the plug-in device (12, 47, 150) is described as being a control device, such as an industrial timer. The present invention, however, is not limited to plug-in control devices. Other plug-in devices, such as plug-in sensors, meters and monitors may be constructed in accordance with the present invention.

While the invention has been shown and described with respect to particular embodiments thereof, those embodiments are for the purpose of illustration rather than limitation, and other variations and modifications of the specific embodiments herein described will be apparent to those skilled in the art, all within the intended spirit and scope of the invention. Accordingly, the invention is not to be limited in scope and effect to the specific embodiments herein described, nor in any other way that is inconsistent with the extent to which the progress in the art has been advanced by the invention.

1. A plug-in device comprising:
a circuit board comprising a first resin and having first and second sides, said first side having conductive tracks;
a plastic base secured to the circuit board and disposed on the second side thereof, said plastic base being configured for at least partial insertion into a socket and a portion of said plastic base extending through the circuit board, said plastic base being comprised of a second resin that is different than the first resin;
a plurality of conductor pins secured to the circuit board and extending through the plastic base, said conductor pins each having a first portion disposed in the plastic base and a second portion extending outwardly from the plastic base; and
electrical circuitry disposed on the first side of the circuit board and electrically connected to the conductive tracks and the conductor pins.

2. The plug-in device of claim 1, wherein the second resin of the plastic base is a thermoplastic resin and the first resin of the circuit board is a thermoset resin.

3. The plug-in device of claim 2, wherein the circuit board has a plurality of through-holes formed therein, and wherein portions of the plastic base extend through the through-holes so as to secure the plastic base to the circuit board.

4. The plug-in device of claim 3, wherein the circuit board is insert-molded into the plastic base.

5. The plug-in device of claim 4, wherein the conductor pins are composed of metal and each conductor pin has at least one protrusion for promoting the mechanical anchoring of the conductor pin to the base.

6. The plug-in device of claim 3, wherein the portions of the plastic base extending through the through-holes are heat staked.

7. The plug-in device of claim 1, wherein the electrical circuitry comprises a relay secured to the first side of the circuit board and a control circuit for controlling the operation of the relay.

8. The plug-in device of claim 7, wherein the control circuit comprises a microcontroller.

9. The plug-in device of claim 7, wherein the plug-in device is a timer and the control circuit is operable to perform a timer control routine that controls the operation of the relay.

10. The plug-in device of claim 1, wherein the second side of the circuit board has a plurality of pads connected to conductive tracks, and wherein the conductor pins are soldered to the pads.

11. The plug-in device of claim 1, wherein the conductor pins are through-hole mounted to the circuit board.

12. The plug-in device of claim 1, wherein the conductor pins are arranged in a substantially circular pattern.

13. The plug-in device of claim 12, wherein the plastic base comprises a key shaft adapted for insertion into the socket, and wherein the conductor pins are disposed at least partially around the key shaft.

14. A plug-in device comprising:
a circuit board having conductive tracks and at least one dielectric layer comprised of a first resin;
a plastic base having a key shaft adapted for insertion into a socket, said plastic base being secured to the circuit board and comprising a second resin that is different than the first resin; and
a plurality of conductor pins secured to the circuit board and extending through the plastic base, said conductor pins being disposed around the key shaft.

15. The plug-in device of claim 14, wherein the circuit board has a plurality of through-holes formed therein, and wherein portions of the plastic base extend through the through-holes so as to secure the plastic base to the circuit board.

16. The plug-in device of claim 15, wherein the base is molded to the circuit board and wherein the conductor pins each have a first portion with at least one protrusion and a second portion with a free end, and wherein the at least one protrusion of each conductor pin is secured in the plastic base to promote the mechanical anchoring of the conductor pin to the plastic base.

17. The plug-in device of claim 16, wherein the conductor pins are composed of metal and wherein in each conductor pin, the at least one protrusion comprises a plurality of protrusions that are annular and are axially spaced-apart.

18. The plug-in device of claim 15, wherein the portions of the plastic base extending through the through-holes are heat staked.

19. The plug-in electrical switching device of claim 14, wherein the circuit board has first and second sides, said second side including the conductive tracks and a plurality of pads connected to the conductive tracks, and wherein the conductor pins are surface mounted to the pads.

20. The plug-in electrical switching device of claim 19, further comprising a relay secured to the first side of the circuit board and electrically connected to the conductor pins.

21. A method of forming a plug-in device, said method comprising:
providing conductor pins and a circuit board with conductive tracks;
soldering the conductor pins to the circuit board so as to be connected to the conductive tracks; and
molding a base from a plastic resin with the circuit board as an insert such that the base has a key shaft adapted for insertion into a socket and such that the conductor pins extend through the base and are disposed around the key shaft.

22. The method of claim 21, wherein the circuit board comprises a first side and a second side with pads, and wherein the soldering of the conductor pins comprises soldering the conductor pins to the pads on the second side of the circuit board.

23. The method of claim 22, further comprising securing electrical components to the first side of the circuit board.

24. A method of forming a plug-in device, said method comprising:
providing conductor pins;
providing a circuit board with conductive tracks and a plurality of through-holes;
providing a plastic base having a first side with a key shaft extending therefrom and a second side with a plurality of studs extending therefrom, said plastic base having a plurality of pin passages extending between the first and second sides;
soldering the conductor pins to the circuit board so as to be connected to the conductive tracks; and
disposing the plastic base over the circuit board such that the conductor pins extend through the pin passages and the studs extend through the through-holes; and
heat staking the studs to secure the plastic base to the circuit board.

25. The method of claim 24, wherein the first side of the plastic base has a recess formed therein, a key passage extends through the key shaft, and the pin passages and the key passage have openings disposed in the recess, and wherein the method further comprises injecting an adhesive into the key passage such that the adhesive travels through the key passage, into the recess and against the circuit board, whereby when the adhesive cures, a bond is formed securing the plastic base to the circuit board.
